(19) United States
(12) Patent Application Publication
(10) Pub. No.: US 2025/0351007 A1
(43) Pub. Date: Nov. 13, 2025

(54) METHODS TO MANAGE QOS AND QOE IN 6G

(71) Applicant: InterDigital Patent Holdings, Inc., Wilmington, DE (US)

(72) Inventors: Rocco Di Girolamo, Laval (CA); Ulises Olvera-Hernandez, Saint-Lazare (CA); Saad Ahmad, Montreal (CA); Samir Ferdi, Kirkland (CA); Michael Starsinic, Newtown, PA (US); Milind Kulkarni, Hawthorn Woods, IL (US)

(73) Assignee: InterDigital Patent Holdings, Inc., Wilmington, DE (US)

(21) Appl. No.: 18/657,017

(22) Filed: May 7, 2024

(51) Int. Cl. H04W 28/24; H04W 24/08; H04W 60/00

(52) U.S. Cl. CPC H04W 28/24; H04W 24/08; H04W 60/00

(57) ABSTRACT

The present disclosure is directed to implementations of systems and methods for quality-of-experience (QoE)-aware quality-of-service (QoS) management for network flows. In some implementations, a wireless transmit receive unit (WTRU) may transmit to a network a registration request comprising quality-of-experience (QoE) assistance information. The WTRU may receive, from the network, a registration acceptance response indicating a QoE-Aware Quality-of-Service Function (QQF) of the network is configured to provide flow control or QoS management for an application of the WTRU based on the QoE assistance information. The WTRU may execute the application and monitor a QoE score during execution of the application. Responsive to a change in the QoE score, the WTRU may transmit to the QQF one or more network or application performance measurements.

### BACKGROUND

Quality of service (QoS) has been used as a metric for managing communication flows between devices, including management of priority, congestion control, path selection, etc. However, QoS is objective, focusing on application requirements and data flow characteristics. Quality of experience (QoE), by contrast, is more subjective, focusing on the overall quality of the telecommunications services being provided to an end user or user associated with a device. QoE may differ between users due to this subjectivity, and it may be influenced by personal experiences and expectations of the individual user. While QoE is most accurately measured subjectively by the end user, it may sometimes be estimated via objective measurements and determinations.

In some implementations of communications systems, QoE and QoS are considered as comparable and correlated metrics—that is, some implementations assume that the better the QoS (e.g. bit rate, loss, etc.) of a connection, the better the QoE of users utilizing that connection. However, this is not always the case. A user may have a service which has enough bandwidth, but the flows are slightly out-of-sync, resulting in a poor experience. Or a video bit rate may be adequate, but the screen resolution is dynamically changed in a frequent and annoying way (e.g. as the network adapts to changing conditions). Accordingly, a system that is agnostic to these differences between QoE and QoS may adapt to network conditions in a naive way that ends up impairing QoE.

### SUMMARY

The present disclosure is directed to implementations of systems and methods for quality-of-experience (QoE)-aware quality-of-service (QoS) management for network flows. In some implementations, a wireless transmit receive unit (WTRU) may transmit to a network a registration request comprising quality-of-experience (QoE) assistance information. The WTRU may receive, from the network, a registration acceptance response indicating a QoE-Aware Quality-of-Service Function (QQF) of the network is configured to provide QoS flow control or QoS management for an application of the WTRU based on the QoE assistance information. The WTRU may execute the application and monitor a QoE score during execution of the application. Responsive to a change in the QoE score, the WTRU may transmit to the QQF one or more network or application performance measurements.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a block diagram of an example implementation of a network system architecture;

FIG. 3 is a block diagram of an example implementation of QoS management;

FIG. 4 is a signal flow diagram of an example implementation of QoE management;

FIGS. 5A, 5B, 6, and 7 are signal flow diagrams of an example implementation of QoE-Aware QoS handling of a flow; and

FIG. 8 is a flow chart of an implementation of a method for QoE-Aware QoS handling of a flow.

### DETAILED DESCRIPTION

The following is a non-exhaustive list of abbreviations and acronyms used herein, provided for reference purposes only. Some utilized acronyms may not appear in the following list, but may be defined in context where they appear. Additionally, some acronyms may have multiple or alternative definitions in addition to the following. One of skill in the art may readily understand their usage in context.
5GC/6GC 5G/6G Core
5GS/6GS 5G/6G System
5QI 5G QoS Identifier
AF Application Function
AMF Access and Mobility Management Function
API Application Program Interface
ARP Allocation and Retention Priority
AS Application Server
CN Core Network
DRB Data Radio Bearer
eMBB enhanced Mobile Broadband
GFBR Guaranteed Flow Bit Rate
GBR Guaranteed Bit Rate
GTP-U General Packet Radio System (GPRS) Tunnelling Protocol User Plane
HTTP Hypertext Transfer Protocol
KPI Key Performance Indicator
KVI Key Value Indicator
MCE Measurement Collection Entity
MFBR Maximum Flow Bit Rate
MOS Mean Opinion Score
MT Mobile Terminal
NAS Non-Access Stratum protocol
NEF Network Exposure Function
NF Network Function
NG Next Generation
NG-RAN Next Generation Radio Access Network
NWDAF Network Data Analytics Function
OAM Operations, Administration and Maintenance
PCC Policy and Charging Control
PCF Policy and Charging Control Function
PDB Packet Delay Budget
PDR Packet Detection Rule
PDU Protocol Data Unit
PER Packet Error Rate
QoE Quality of Experience
QoS Quality of Service
QQF QoE-Aware QoS Function
RAN Radio Access Network
RQA Reflective QoS Attribute
RRC Radio Resource Control protocol
SBA Service Base Architecture
SBI Service Based Interface
SMF Session Management Function
TCE Trace Collection Entity
UDM Unified Data Management
UDR Unified Data Repository
UP User Plane
UPF User Plane Function
URLLC Ultra Reliable and Low Latency Communication

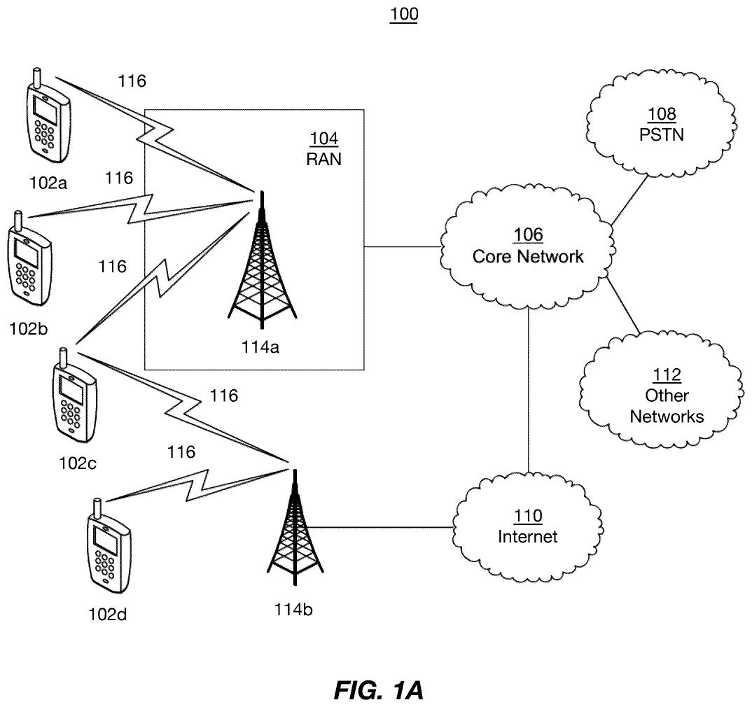

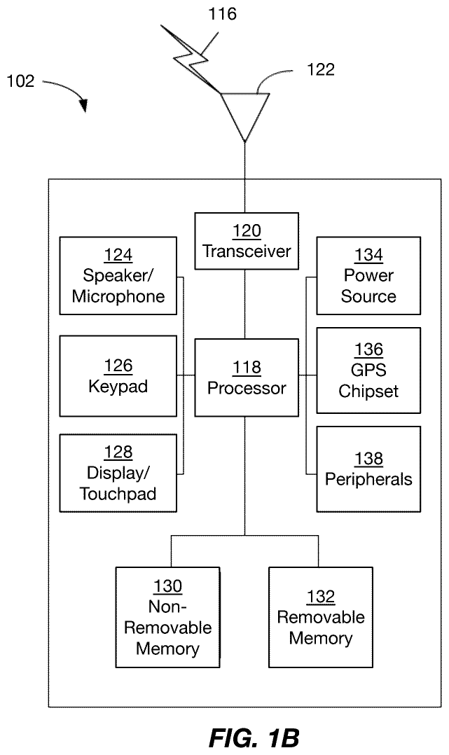

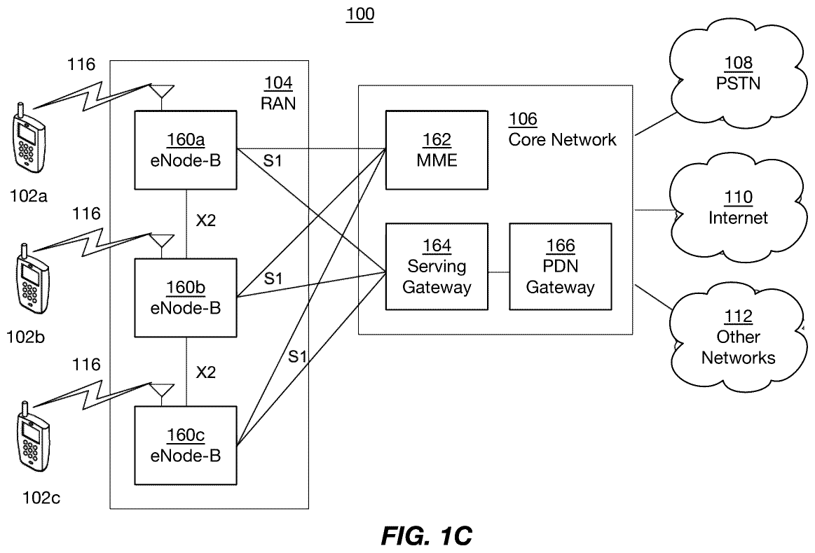

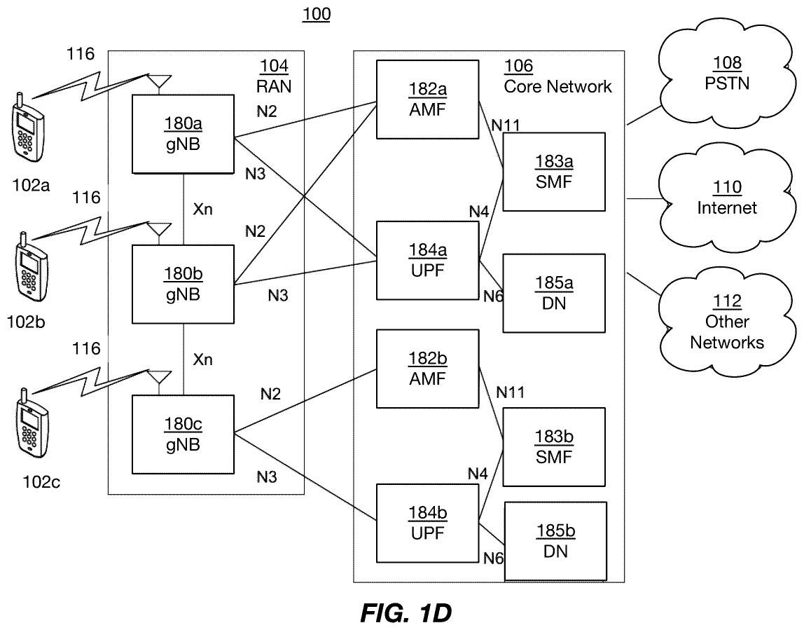

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

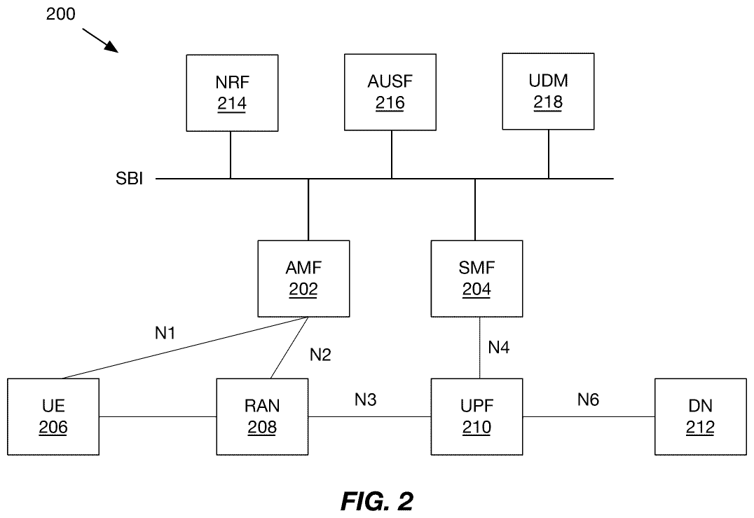

FIG. 2 is a block diagram of an example implementation of a network system architecture 200. In the illustration, only a subset of the Network Functions (NFs) in the 5G Core are represented. For example, the NFs include an Access and Mobility Management Function (AMF) 202, Session Management Function (SMF) 204, Network Repository Function (NRF) 214, Authentication Server Function (AUSF) 216, and Unified Data Management (UDM) 218, which may communicate with each other using a Service Based Interface (SBI) (using protocols like HTTP). The goal of the Service Base Architecture (SBA) is to enable NFs to expose services (e.g., using RESTful APIs) to other NFs, for the system to provide the desired functionality.

The other interfaces shown (Nx) in FIG. 2 and described below may be different from SBI. For example, a UE may communicate with an AMF over N1 using a NAS protocol. Control plane messaging between the UE and other NFs (e.g., SMF) may be done using a NAS transport encapsulation mechanism provided by AMF for the NFs. Other network nodes communicating via NAS protocols or other protocols may include a Radio Access Network (RAN) 208, User Plane Function (UPF) 210, and Data Network (DN) 212. As discussed above, each of these logical nodes or network functions may be provided by one or more computing devices, including virtual or physical computing devices, groups of devices, clusters, server clouds or virtual machine clouds, etc. In many implementations, multiple network functions may be provided by a single computing device or group of devices (e.g. a device providing an AMF node may also provide an SMF node, in some implementations). In other implementations, network functions may be provided by different devices, and even individual functions may be distributed amongst a plurality of devices (e.g. in parallel or serial architectures).

As discussed above, quality of service (QoS) has been used as a metric for managing communication flows between devices, including management of priority, congestion control, path selection, etc. For example, in 5GS, QoS management is based on QoS flows. All PDUs in a QoS flow receive the same treatment in the RAN and in the UPFs in the core network. The QoS Flow is the finest granularity of QoS differentiation in the PDU Session. A QoS flow has QoS requirements: 5QI (including resource type, Priority Level, PDB, PER, Averaging Window, Maximum Data Burst Volume), ARP, RQA, Notification Control, Flow Bit Rates (MFBR, GBR), Aggregate Bit Rates, Maximum Packet Loss Rates.

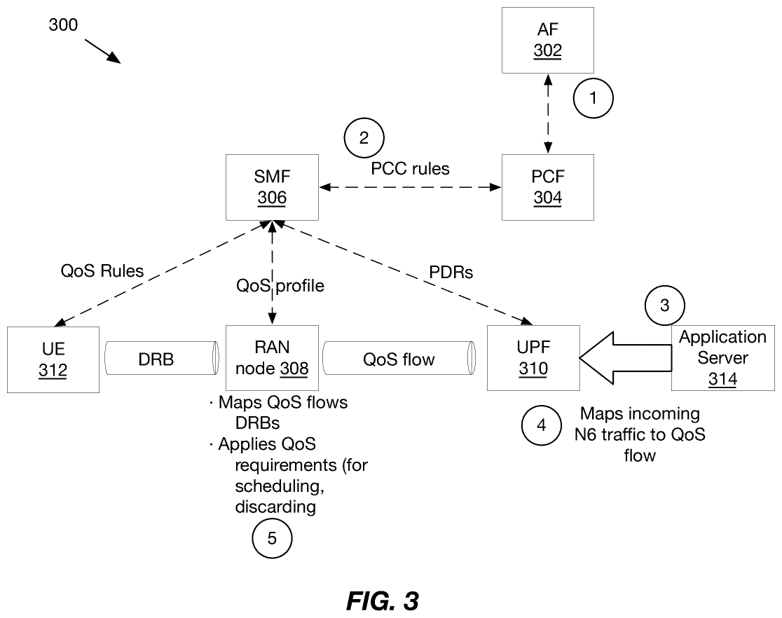

Some implementations enabling QoS management in a 5G system (5GS) 300 are illustrated in the block diagram of FIG. 3. At 1, an Application Function (AF) 302 may provision the network (e.g. a policy control function (PCF) 304) with QoS requirements of the traffic flows. This may be done, for example, using a NEF service API such as Nnef_AFsessionWithQoS_Create.

At 2, QoS information is used by the PCF 304 to configure PCC rules, which may be provided to a session management function (SMF) 306. Based on the rules configured in the PCF 304, the SMF 306 can then configure a RAN node 308 with a QoS profile, the UPF 310 with packet detection rules (PDRs) or similar filters, and the UE 312 with QoS rules or similar filters.

At 3, a PDU may arrive at the UPF 310 over the N6 interface (e.g. from an application server 314).

At 4, using the configured PDRs or similar filters, the UPF 310 may map the traffic to a QoS flow. The UPF 310 may create a tunnel to the RAN node 308 and sends the arriving PDU to the RAN node 308 encapsulated in a suitable protocol (e.g. in a General Packet Radio System (GPRS) Tunnelling Protocol User Plane (GTP-U) packet).

At 5, the RAN node 308 uses the configured QoS profile to determine how to manage the GTP-U packet. This management may include how to schedule the packet to the UE 312 and/or whether the packet should be discarded. If scheduled, the packet is transmitted to the UE 312 on a configured Data Radio Bearer (DRB).

Additional processing has been defined for virtual reality (VR), augmented reality (AR), extended reality (XR) or similar media traffic (referred to generally as XR traffic). For example, the XR traffic may be transmitted as PDU sets. The QoS profile may have requirements that target PDU sets. Furthermore, the header of the GTP-U PDU may carry PDU set information.

As discussed above, QoS is objective, focusing on application requirements and data flow characteristics. Quality of experience (QoE), by contrast, is more subjective, focusing on the overall quality of the telecommunications services being provided to an end user or user associated with a device. For example, ETSI TS 102 250-1 defines QoE as “the inclusion of the user himself to the overall quality in telecommunications extends the rather objective Quality of Service to the highly subjective Quality of Experience. The QoE differs from user to user since it is influenced by personal experiences and expectations of the individual user.” Recommendation ITU-T P.10/G. 100 defines QoE as: “the degree of delight or annoyance of the user of an application or service. It includes the complete end-to-end system effects (client, terminal, network, services infrastructure, etc.) and may be influenced by user expectations and context. Hence the QoE is measured subjectively by the end-user and may differ from one user to the other. However, it is often estimated using objective measurements.” While these definitions are not intended to be exhaustive or comprehensive, QoE accordingly takes into account more subjective or experiential factors than QoS. QoE may differ between users due to this subjectivity, and it may be influenced by personal experiences and expectations of the individual user. While QoE is most accurately measured subjectively by the end user, it may sometimes be estimated via objective measurements and determinations.

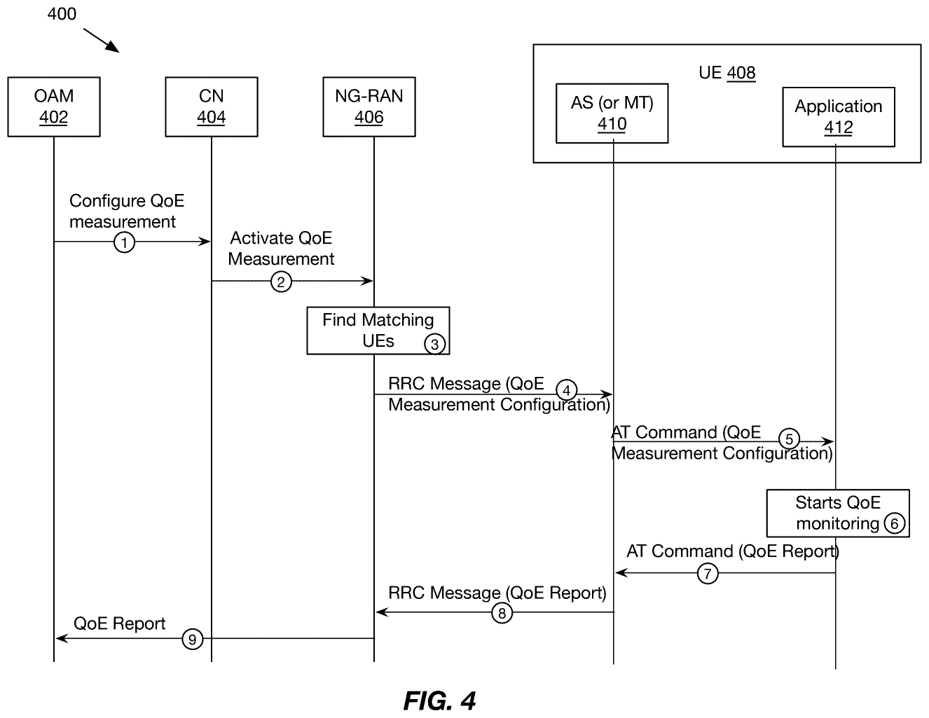

FIG. 4 is a signal flow diagram of an example implementation of QoE management. QoE is supported by application layer measurement collection. In many implementations, QoE is intended to be used by the Operations, Administration and Maintenance (OAM) system 402. The trigger to the OAM system is typically based on a request from an operator (not illustrated). At 1, the OAM system 402 sends a measurement configuration to the NG RAN node 406 (e.g. forwarded via a core network 404 at 2). At 3, the NG-RAN node 406 may find UEs with the capabilities that match the request from the OAM system 402. The matching UEs (408) are provided the QoE measurement configuration at 4, e.g. via an RRC message. The RRC message is received by the UE 408 at 4 and QoE measurement reporting is configured at 5 for the application layer 412 of the UE by the access stratum (AS) or MT 410 of the UE 408. QoE measurement reporting can be time based or event based. Once configured, at 6, the QoE reports are initiated by the application layer 412 of the UE 408. The QoE reports are transferred to the access stratum 410 of the UE 408 via AT commands at 7, and then to the NG-RAN node 406 inside a QoE Report container, via a RRC message at 8. The NG-RAN node 406 may then send the QoE report container to the final destination configured by OAM 402, e.g., the trace collection entity (TCE) or measurement collection entity (MCE) (not illustrated). The QoE report may contain one or more QoE metrics, in various implementations. These metrics may be objective (i.e. measurable) metrics such as corruption duration, frame rate, jitter duration, round trip time, etc.).

In many implementations, next generation network use cases may be divided into 4 classes based on common characteristics:
Enhanced Human Communication—such as immersive experience, telepresence and multimodal interaction;
Enhanced Machine Communication—such as robotic communication and interaction;
Enabling Services—such as positioning, mapping, automatic protection, smart health, and manufacturing; and
Network Evolution—such as Native Artificial Intelligence (AI) exposed as a service, energy efficiency, and coverage.

These use cases have very demanding requirements, with respect to Key Performance Indicators (KPIs)—such as delay, throughput, jitter. In addition, the use cases may have requirements with respect to Key Value Indicators (KVIs) related to sustainability, energy consumption, privacy, security, and resiliency. Networks not implementing the systems and methods discussed herein may have difficulty meeting these KPIs and KVIs. In particular, such networks may have some potential inefficiencies and limitations related to managing QoS for these next generation use cases.

In many instances, 5G networks do a good job for certain use cases. For example, for use cases requiring very high bit rate/throughput, 5G provides solutions such as use of an eMBB network slice, enhancements to the PHY layer, new frequencies, Dual Connectivity, Carrier Aggregation, ATSSS, etc. Similarly for use cases requiring extremely low latency, 5G provides solutions such use of URLLC network slice, pre-emption, and flexible transmit start times.

However, the 6G use cases are even more demanding. Some require both high throughput and low latency (e.g. augmented reality, hologram telepresence). Some require additional metrics not considered in 5G QoS (e.g. jitter). In addition, some of these use cases may also require that the network meet requirements related to KVIs. 5G networks lacking the features discussed herein may not be able to support these 6G use cases.

In addition, such networks, Quality of Experience is typically always tied to QoS or considered to be correlated. That is, it was always assumed that the better the QoS (e.g bit rate, loss) the better the QoE. But this is not always the case—a user may have a service which has enough bandwidth, but the flows are slightly out-of-sync, resulting in a poor experience. Or in some instances, a video bit rate may be fine or adequate, but due to dynamic resolution changes, the user may find the viewing experience annoying (for example, as the network adapts to changing conditions).

Viewed from another perspective, two users may have different QoE expectations from the same service. For example, two players playing the same immersive experience online game may not have the same visual acuity and hand-eye coordination (this may also be a result of other non-wireless devices, such as lower resolution or frame rate monitors or displays with higher internal latencies, lower resolution game controllers, etc.). In such cases, it may not be necessary for the network to provide the same QoS to both players, and instead provide a prioritized or higher quality version to the player best able to perceive it, without adversely affecting the other player's subjective experience. That is, each player may subjectively rate the QoE as equally high quality, but may receive objectively different quality versions (e.g. higher or lower resolutions, lower latency versions, versions with narrower fields of view or narrower foveation parameters, versions with lower resolution background textures, versions with more compressed audio, etc.).

Addressing these new use cases envisioned in 6G requires additional consideration of new QoS metrics and requirements that may need to be provided to the 6G system to properly reflect the requirements of these new use cases, and how the 6G system can meet the QoS metrics/requirements for the 6G use cases. This may require evolving the network (and expectations) from a “best-effort” network to a “mixed” network—where some services will use the 5G “best effort” model and other services will use a “guaranteed” or “reserved transport” model.

In the guaranteed (or reserved transport) model, capacity in the core network and radio access network is reserved. Implementations of the systems discussed herein enable decisions as to where and how to reserve this capacity, incorporation of new QoE metrics and requirements, and the use of QoE metrics to change how UL/DL data is transmitted over the 6G system.

As used herein, the terms “service traffic” and “traffic flow” may be used to denote traffic generated by an application. A service may generate traffic that is transmitted over a single traffic flow. A service may generate traffic that is sent over multiple traffic flows.

As used herein, the term “QoE information” may be used to denote information related to the perceived experience of an end user. The QoE information may also be a metric calculated by an application (e.g. in a UE or an application server) which represents some measured level of QoE. The QoE information may be provided as a score (e.g. Mean Opinion Score (MOS)).

As used herein, the term “QoE Assistance information” may be used to denote information that may be provided to the 6GS (or that may be determined by the 6GS) and that may be used to tailor how the 6GS handles QoS for a service.

As used herein, the term “QoS handling” may be used to denote mechanisms used in the 6GS to provide the necessary QoS to the QoS flows and the PDUs carried on these QoS flows. The necessary QoS is determined by the type of QoS flow. For example, the QoS provided to a QoS flow that uses reserved transport, is more stringent than the QoS provided to a non-GBR QoS flow.

As used herein, the term “Reserved Transport” may be used to denote mechanisms used in the 6GS to guarantee delivery of service traffic. If Reserved transport is needed, the 6GS reserves capacity in all transport links and in all entities involved in the user plane transport path of the service traffic. This may be in contrast to the “best-effort” transport used in 5GS, where capacity is not typically reserved, and where the network tries to meet GBR requirements for service flows. In a “best-effort” transport case, as the capacity is not reserved, the network may occasionally fail to meet the GBR requirements.

As used herein, the term “entity in user plane path” or “entity in user plane transport path” are used interchangeably, to denote any entity or node that handles/processes user plane PDUs of a traffic flow. For example: a UPF, or RAN node, or UE. User plane PDUs 1) arrive (are received) at these entities, 2) may be stored at these entities; 3) may be scheduled to be transmitted by these entities; 4) leave (are transmitted) by these entities.

As used herein, the term “UE may be pre-configured” may be used to refer to behavior or rules that are known to the UE or WTRU and are followed by the UE or WTRU. For example, a UE or WTRU may need to follow some behavior to be compliant to a standard (e.g. 3GPP).

As used herein, the term “UE may be configured” may be used to refer to behavior or rules that are provided to the UE or WTRU through signaling exchanges. The signaling exchange is with the RAN node or with some network function in the core network.

As used herein, the terms “QoE aware QoS handling” and “QoE aware QoS” may be used interchangeably, to denote QoS handling that takes into account QoE Information and QoE Assistance information. This allows a network, based on QoE, to change offered QoS of a QoS flow.

As used herein, the term “Offered QoS” may be used to denote the QoS level provided by the network to a QoS flow. It may be based on the QoS parameters of a QoS flow.

As used herein, the term “Required QoS” may be used to denote the minimum QoS requirements required for a QoS flow. The assumption may be that if the network Offered QoS>=Required QoS, then the majority of users will experience good QoE. For a QoS flow requiring “Reserved transport”, and with “QoE aware QoS handling” not enabled, the network has to reserve capacity to meet the Required QoS, so the Offered QoS must be>=Required QoS.

In order to allow QoE-Aware QoS handling for 6G systems, implementations of the systems and methods discussed herein provide new QoS parameters tailored for 6G use cases, including the related information provisioned from the AF/AS; a mechanism for 6G systems to use QoE Assistance information to scale required QoS for a service; a mechanism to configure the UE to measure and report QoE information to the network; a new network function (QoE-Aware QoS Function or QQF) to manage QoE-Aware QoS handling; and/or a mechanism for the network (e.g. SMF) to configure QoS flows requiring reserved transport and/or enabled for QoE-Aware QoS handling.

In a first aspect, the present disclosure is directed to implementations of systems and methods for UE or WTRU operation to support QoE-aware QoS handling. In brief overview, in some implementations, a UE or WTRU may be interested in (e.g. configured for working with a network providing) QoE-Aware QoS handling for a service requiring reserved transport levels of QoE (i.e., the network reserves capacity in all transport links and in all entities involved in the user plane transport path of the service traffic). Such services may include real-time telepresence or XR media, or similar uses. In some implementations, the UE or WTRU may register to the 6G network and provide QoS Assistance information, UE ID, and, in some implementations, a User ID. In some implementations, the UE or WTRU starts the service requiring reserved transport, and may determine if the serving network is suitable for the service. If not, the UE or WTRU may deregister from the serving network and register with another serving network. In some implementations, the UE or WTRU may determine if the serving RAN node is suitable for the service. If not, the UE or WTRU may change the serving RAN node. The UE or WTRU may make this determination based on system information, QoS measurements, etc. In some implementations, the UE or WTRU may start a PDU session establishment request. The request may include an indication that the UE or WTRU wants QoE-aware QoS handling for this PDU session, an indication that the UE or WTRU wants reserved transport, QoE information, and/or any other such information. In some implementations, the UE or WTRU may receive a PDU Session establishment acceptance response. The response may include QoE monitoring and reporting configuration, in some implementations. In some implementations, the UE or WTRU begins QoE monitoring and reporting processes. If triggered (e.g. by a measurement exceeding a threshold or matching a filter or policy), the UE or WTRU may send QoE Information to the network. The QoE Information may include: service ID, UE ID, user ID, and/or QoE information. In some implementations, in response to the sent QoE information, the UE or WTRU may receive a request to modify the PDU session.

In a second aspect, the present disclosure is directed to a QQF network function to support QoE-Aware QoS handling. In some implementations, a QQF may receive QoE Assistance Information from an AMF. The Information may include a User ID and/or UE ID. In some implementations, the QQF stores received QoE Assistance information in UDM/UDR. In some implementations, the QQF receives QoE-Aware QoS Handling information from the AF/AS and/or NWDAF. In some implementations, the QQF receives a request from PCF for a QoS scaling factor for a new QoS flow and/or to subscribe to changes in Offered QoS for the QoS flow. In some implementations, the QQF determines the QoS scaling factor to apply for a new QoS flow. In some implementations, the QQF provides the QoS scaling factor to apply for a new QoS flow, to the PCF. In some implementations, the QQF receives QoE information from a UE or WTRU. In some implementations, the QQF determines a new Offered QoS for a QoS flow, and provides the new Offered QoS to the PCF

In more detail, some implementations of a QoS/QoE model for 6GS may possess one or more of the following properties:

Property 1: In some implementations, the UE may start a connectivity service with a data network. This will be referred to as a PDU session to be in line with 5GS nomenclature, but it should be understood that the properties of a 6G PDU session may be different from that of a 5G PDU session. In some implementations, the UE or WTRU may have multiple established connectivity services to the same data network and/or to different data networks.

Property 2: In some implementations, the PDU session will have QoS flows, and the network may provide similar QoS handling on all PDUs that belong to the same QoS flow. Differentiated QoS handling may be permitted on a QoS flow, for example, based on metadata that may be included in the PDUs transferred over the QoS flow. Integrated QoS handling may also be permitted on a QoS flow, for example, based on metadata that may be included in the PDUs over the QoS flow. In some implementations, the 6GS may support many types of QoS flows. Example QoS flow types may include:
Non-GBR: In some implementations, these are QoS flows that may carry services that do not require a minimum bit rate. The services using non-GBR QoS flows may be best effort services.
GBR: In some implementations, these are QoS flows that may carry services that require a minimum bit rate for survival.
Delay Critical GBR: In some implementations, these are QoS flows that may carry services that require a minimum bit rate for survival as well as some maximum latency
Reserved Transport: In some implementations, these are QoS flows that require reserved resources in the 6GS to guarantee one or more criteria (for example a bit rate, a maximum latency, minimum jitter, etc.).
Differentiated Handling: In some implementations, a QoS flow with differentiated handling may allow the 6GS to treat individual PDUs in the QoS flow slightly differently. For example, the QoS flow may support PDU sets and allow PDU set QoS handling mechanisms to these PDU sets. As another example, some PDUs of the QoS flow may require special handling by the 6GS since these PDUs may contain important control plane signaling.
Integrated Handling: In some implementations, a QoS flow with integrated handling may allow the 6GS to perform some QoS handling across one or more QoS flows. For example, there may be timing requirements across two QoS flows to allow for multi-modal services.
   Some of the QoS flow types may occur concurrently. For example, a QoS flow may be of GBR type and also support integrated handling.

Property 3: In some implementations, the network may control the mapping of traffic flows to QoS flows. The mapping functionality may be performed at the user plane ingress point (e.g. UPF) for DL traffic and at the UE for uplink traffic. Mapping of traffic flows to QoS flows may be flexible, that is M:1 mapping of traffic flows to QoS flows (M>=1).

Property 4: In some implementations, each QoS flow may be characterized by QoS parameters. The QoS parameters include information related to requirements linked to the traffic in the QoS flow as well as details related to properties of the QoS flow. The QoS flow properties may include QoS flow type(s), priority, as well as information on how 6GS network elements deal with the QoS flow. For example, the information may include configurations for ARP, RQA, notification control, or other such information. The QoS flow requirements may include requirements similar to those used in 5GS, namely: packet delay budget, packet error rate, Maximum Data burst Volume, guaranteed flow bit rates (for UL and DL), maximum flow bit rates (for UL and DL), maximum packet loss rates (for UL and DL), and/or aggregated bit rates. The QoS flow requirements may include additional requirements, namely:
Maximum jitter (for UL and DL): In some implementations, this denotes the maximum jitter that may be tolerated by traffic of a QoS flow. Any entity in the user plane transport path of a traffic flow may monitor and calculate jitter. An entity may know the expected arrival time of all PDUs of a service. Based on the expected arrival time of PDUs, and the true arrival time of PDUs, the entity may calculate the jitter associated with the traffic flow and determine whether this requirement is being met. The requirement denotes the maximum jitter between the true arrival time of a PDU and expected arrival time of a PDU. If this level is exceeded, in some implementations, the traffic from a traffic flow may be unusable. Alternatively, if this level is exceeded, an entity may change how it processes a PDU, in order to guarantee the jitter requirement for a subsequent node on the user plane path. For example, if an entity has calculated a jitter and determined that the jitter in the traffic flow has increased, in some implementations, the entity may compensate by giving priority to the PDUs to try to reduce the jitter.
Maximum inter-flow latency (between two ULs, between two DLs, between UL and DL): In some implementations, the maximum inter-flow latency between two UL QoS flows applies to the case where a UE generates multi-modal data, where each data modality may have different QoS requirements (and may be mapped to different QoS flow) but where the traffic from the two data modalities needs to be synchronized (e.g. synchronized audio and video data, with separate QoS requirements). The requirement denotes the maximum tolerable difference in packet delay over the two UL QoS flows. If this level is exceeded, in some implementations, the traffic from the two data modalities will be out-of-sync and unusable. Similarly, the maximum inter-flow latency between two DL QoS flows applies to the case where an AS generates multi-modal data, where each data modality may have different QoS requirements (and may be mapped to different QoS flows) but where the traffic from the two data modalities needs to be synchronized. The requirement denotes the maximum tolerable difference in packet delay over the two DL QoS flows. If this level is exceeded, in some implementations, the traffic from the two data modalities will be out-of-sync, and unusable. The maximum inter-flow latency between an UL QoS flow and DL QoS flow applies to traffic that has round trip requirements. In some implementations, the requirement denotes the maximum tolerable UL delay+DL delay. If this level is exceeded, the traffic from this service will not meet the RTT requirement. In each case above, the packet delay is measured between the UE and the UPF.
Maximum age: In some implementations, this denotes the maximum age or freshness of traffic over a QoS flow. Traffic with a maximum age requirement is only useable if fresh. That is, the current age is less than the maximum age. The various entities in the user plane transport path may evaluate the age of a PDU. This may be based on the current time and the PDU creation time. If a PDU is old (age>maximum age), in some implementations, the PDU may be dropped.

Property 5: In some implementations, the QoE may be taken into consideration in the QoS model. QoE may impact QoS flows. How QoE impacts a QoS flow may be based on whether QoE information is static or dynamic.

Quality of Experience is subjective, as it depends on the end user's perception of the quality of a service. As a result, a service which has received the same QoS treatment during transmission, may result in very different QoE perceived by two different end users, or even by the same end user but at different times. QoE may be impacted by factors which are:
Static: such as user's age, user's health, user's physical surroundings, etc. These factors may change, but the change is very slow. Typically they do not change during a service session.
Dynamic: such as user's mood, viewing angle of the device. These factors may change during a service session.

Knowledge of user's QoE, allows the network to enable “QoE-Aware QoS handling”. Every service has a set of QoS requirements that is referred to as “Required QoS”. This service is mapped to a QoS flow in the 6GS which provides an “Offered QoS” to the service, based on the QoS parameters and characteristics of the QoS flow. If the 6GS meets the QoS requirements of a service, that is if the “offered QoS” is larger than or equal to the “required QoS”, then the majority of the users using the service will observe or experience a good QoE.

In some implementations, the network should endeavor to have an “offered QoS” bigger than the “required QoS”. However, the offered QoS may reflect the amount of resources consumed in the 6GS to transmit the service. The resources may be over-the-air transmission resources, transport network resources, storage resources in entities in a user plane transport path, etc. If the “offered QoS” is larger than or equal to the “required QoS”, then this may result in overprovisioning the 6GS resources. For example, this may lead to wasted over-the-air capacity or wasted storage resources.

For services mapped to QoS flows with Reserved transport, if the network does not support QoE-Aware QoS handling, then the network may provide an “offered QoS” larger than or equal to the “required QoS”, to every user that is using the service. QoE-Aware QoS handling takes advantage of the fact that some users would observe a good QoE, even if the 6GS offered QoS was reduced. For example, this may be because of some static factor such as the user's age. For these users, there is no incentive for the 6GS to provide the service using an offered QoS that is larger than or equal to the required QoS. These users would be “happy” even if the offered QoS were less than the required QoS. If the offered QoS was reduced for these users, the 6GS may free up some network capacity that it may then use to provide services to other users.

In the following, it is assumed the network will use both QoE Assistance information as well as QoE information to enable QoE-Aware QoS handling. QoE Assistance information can also be provided to the end applications such that they can negotiate lower QoS requirements for the streams, as an application layer solution. However, in some instances, the network may know some QoE Assistance Information that cannot be shared with the end applications (e.g. for privacy concerns).

QoE Assistance Information may be information that reflects the static factors that impact QoE. This information may be qualitative. For example, a description of the user's age or ethnicity, a description of the user's physical condition, a description of the user's environment (e.g. location, time of day, weather, etc.), etc. This information may be used by the 6GS to determine a QoS Scale Factor to apply to the offered QoS of a service. In one possible implementation, the network may be pre-configured with a mapping of how each static factor impacts QoE for a specific service. As an example, a user may have poor eyesight in his left eye. The network knows that this static factor affects QoE, and that the bit rate required for the left eye video stream may be reduced by K% and still be acceptable to the user (QoS Scale Factor==(1−K)%). As a result, the QoS requirement for this video stream may be reduced by K%. The network may map the stream to a QoS flow with this reduced QoS requirement. All packets of this video steam will receive this lower QoS treatment. In some implementations, these scale factors may be set by administrators or users, while in other implementations, scale factors may be determined by a machine learning or artificial intelligence (AI/ML) system. For example, an AI/ML system may determine scale factors based on the underlying QoE Assistance information (e.g. demographic information) and a supervised learning algorithm receiving feedback from users.

QoE Assistance Information may be quantitative, which allows to protect privacy of the user. For example, the QoE Assistance Information may be a number (or a range) that reflects the desired QoS Scale Factor. The UE may be configured or pre-configured with how static factors impact QoE, and based on this (pre) configuration, the UE may determine the QoS Scale Factor. Alternatively, the UE may be able to determine a QoS Scale Factor based on historical monitoring of user behavior when using services.

In a first alternative, QoE Assistance Information related to a user, may be provided to the 6GS, by the UE. In a second alternative, QoE Assistance Information related to a user, may be provided to the 6GS, by the AS/AF. In a third alternative, the 6GS may have some of the QoE Assistance Information stored in a UDM/UDR. For example, based on a prior network interaction by the user, or based on information provided by the user during subscription, or based on user information learned by the 6GS.

QoE Information may be information that reflects the dynamic factors that impact QoE. This information may be quantitative and reflected in a QoE Score. For example, the QoE Score may be a Mean Opinion Score (MOS). In the following it is assumed that the higher the score, the better the QoE. The QoE may change during the lifetime of a session. The network may obtain the QoE Information from the UE. The UE may monitor and determine the QoE Score for a service periodically, based on a configured monitoring periodicity. In some implementations, the score may be explicitly provided by a user (e.g. in response to a questionnaire or prompt or survey, by selecting an element in a GUI indicating a positive or negative experience, etc.) and/or implicitly provided (e.g. by noting an increase or decrease in a user's heart rate, by detecting an annoyed tone of voice, by identifying the user repeatedly selecting a command or clicking a button when repeated presses would have no additional effect, etc.). In some implementations, the network may optionally start and/or stop the periodic reporting. The UE may monitor and determine the QoE Score for a service based on some triggering event. For example, the network may indicate to the UE that it requires a QoE Score. This allows the network to perform QoE aware QoS handling, only when needed. Alternatively, the network may obtain the QoE information from the AS/AF. For example, the user may provide some QoE information to the application server. The Application server may then forward the information to the network. QoE information may be used by the network, to dynamically increase or reduce the Offered QoS provided to a service. For example, the network may de-prioritize the traffic of this service in favor of other services to the same UE or even to different UEs. As another example, the network may temporarily reduce the bit rate guaranteed for this service.

A network that has enabled QoE-Aware QoS handling, may change the offered QoS for an impacted service. In one option, the network may modify the QoS characteristics and parameters of a QoS flow. The modification will impact the user plane processing of all traffic on the QoS flow. In a second option, the network may decide not to modify the QoS characteristics and parameters of a QoS flow, but instead it may provide differentiated handling for some PDUs on this QoS flow—the PDUs of the impacted service.

The QoE information may be provided at a number of granularity levels, which determines how specific the information is. The finer the granularity, the more specific the information is, and the more useful it is for QoE-Aware QoS handling. For example, the QoE score granularity may be:
Per UE: the UE may provide a single global QoE score, based on all services that are monitoring the QoE.
Per user: the UE may provide a QoE score for a specific user, based on all the services of the user, that are monitoring the QoE.
Per service type (or application type): the UE may provide a QoE score for a specific service type, based on all the services of a specific service type (all users of the UE using this service type), that are monitoring the QoE. For example the service type may target all video services, or all video related applications.
Per service: the UE may provide a QoE score for a specific service, for all users of the UE using this service. A service may be an application or a group of applications.
Per service type and per user: the UE may provide a QoE score for a specific service type, based on all the services of a specific service type and for a specific user, that are monitoring the QoE. For example the service type may target all video services.
Per service and per user: the UE may provide a QoE score for a specific service and for a specific user. A service may be an application or a group of applications.

For each granularity level, the QoE information may be provided for one or more of the following criteria. For example, the QoE score criteria may be:
Global: the QoE score reflects a general assessment of the user QoE.
Lag: the QoE score reflects whether a service seems unresponsive to user actions. For example, a user hits a button and the resulting action is not instantaneous
out of sync: the QoE score reflects whether a service is out-of-sync. For example, the audio and video streams are not synchronized
video quality: the QoE score reflects whether the video quality of the service is poor. For example the video may be pixelated.
sound quality: the QoE score reflects whether an audio quality of the service is poor. For example the audio is not discernable.

The QoE Assistance information may be stored in the UDM/UDR. A QoE-Aware QoS function (QQF) may be defined in the network to help manage QoE-Aware QoS handling. The network function may use QoE information and QoE Assistance information to determine if the offered QoS provided to a service needs to be changed. The QQF may be provided by hardware, software, or a combination of hardware and software. For example, the QQF may comprise one or more physical and/or virtual computing devices executing one or more servers, such as policy servers, measurement servers, management servers, or other application services to provide QQF functionality to a network.

The QQF may obtain QoE Assistance information from the UDM/UDR. The QQF may subscribe to the UDM/UDR, to be notified of any change of QoE Assistance Information for a specific user and/or UE.

In many implementations, the QQF obtains the QoE information from the UE or from the AS. This information is maintained in the QQF as part of the UE context. In some implementations, this UE context contains the QoE score per service and per user. In some implementations, the QoE information stored in the UE context in the QQF may have an associated lifetime. If the QoE information is not refreshed by the UE (or AS), in some implementations, the QoE information expires and it is assumed that the underlying QoE condition no longer applies to the user.

In some implementations, the QQF may use the QoE Assistance Information and/or the QoE information to determine the offered QoS. In one alternative, the AF may provide a mapping of QoE information to offered QoS and/or QoE Assistance Information to QoS scaling factor. This information may be stored in the UDM/UDR and retrieved by the QQF when needed. If the QQF determines that the offered QoS needs to be changed, in some implementations, the QQF notifies the SMF, so that the QoS handling for the service may be changed. For example, the SMF may change the QoS characteristics and parameters of a QoS flow, or by provide differentiated handling for some PDUs of the QoS flow.

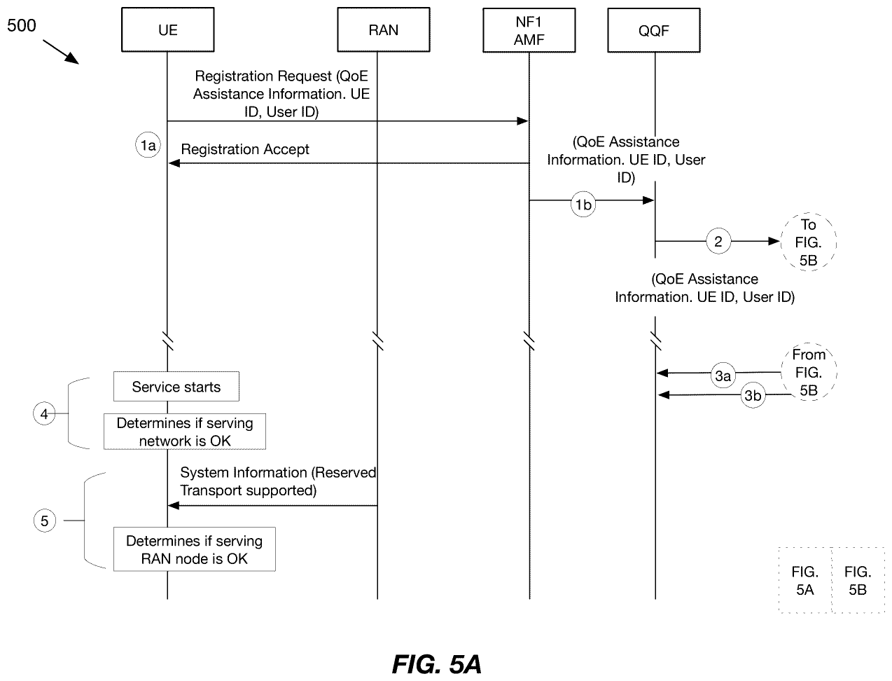

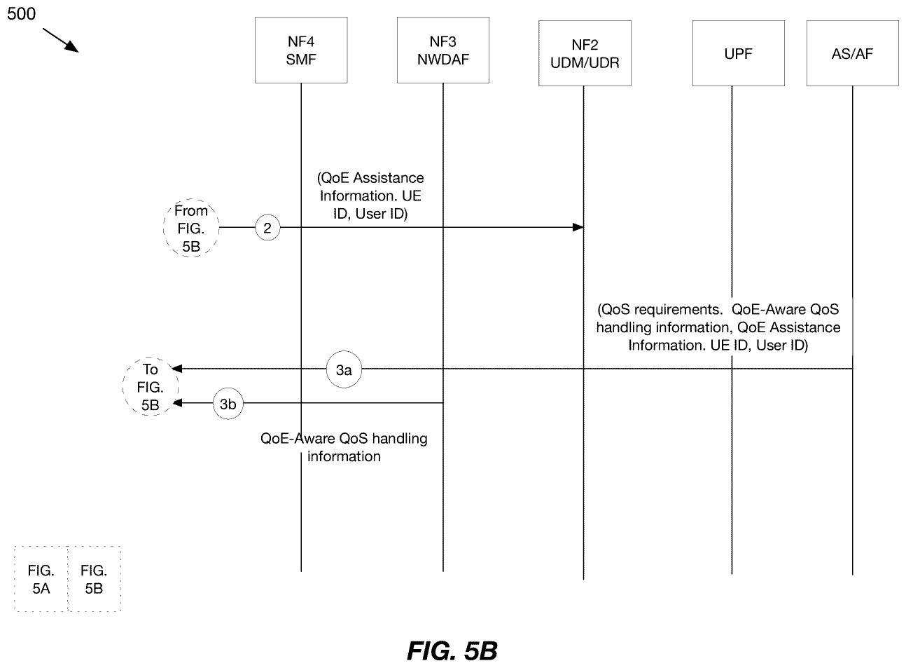

FIGS. 5A and 5B are a signal flow diagram 500 of an example implementation of QoE-Aware QoS handling of a flow. The diagram 500 crosses both figures as shown in lower right and via the dotted circles. In the following call flow, the network control plane messages between the network functions (NFs) and the UE are shown as direct connections. These are logical connections. The actual transport mechanism may be via an Service Based Interface (SBI) between the UE and the network function, or using radio bearers and tunnels between the UE and the network functions.

At 1a, in some implementations, the UE registers with the network (i.e. the serving network). It sends a Registration Request message to a NF1 (e.g. an AMF). The message may include an identifier of the UE, an indication that the UE supports QoE-Aware QoS, an indication that that UE supports reserved transport, and QoE Assistance Information, and/or an identifier of the user. If the NF1 (e.g. AMF) accepts the registration, it may respond by sending a Registration Accept message to the UE. The message may include an indication if the network supports reserved transport and/or QoE-Aware QoS handling.

At 1b, in some implementations, if the UE provided QoE Assistance information in the Registration Request message, NF1 (e.g. AMF) may send a message to the QQF that includes the QoE Assistance information, UE ID, and/or User ID. If the UE provided no QoE Assistance information in the Registration Request message, in some implementations, NF1 (e.g. AMF) may send a message to the QQF that includes the UE ID, and/or User ID.

At 2, and turning to FIG. 5B, in some implementations, the QQF, upon receiving QoE Assistance information, stores the information in NF2 (e.g. UDM/UDR) along with the UE ID and/or User ID.

At 3a, the AS/AF provides QoS information to network. This information includes new QoS requirements for a traffic flow, including some or all of the following:
indication if service requires reserved transport in the 6GS
Required Bit rate for traffic flow—for services requiring reserved transport
Maximum latency for traffic flow—for services requiring reserved transport
Maximum jitter allowed for a traffic flow
Maximum delay between two traffic flows

The AS/AF may also provision QoE-Aware QoS handling information (information to be used for QoE-Aware QoS handling). For example, the network may provision the network with a list of QoS requirements per QoE score or a list of QoS scaling factors per QoE Assistance Information, such as some or all of the following:
List of Required bit rates for the traffic flow: e.g. bit rate k for QoE score x
List of Maximum latency for traffic flow: latency k for QoE score x
List of Maximum jitter allowed for a traffic flow: jitter k for QoE score x
List of QoS Scale factors: {QoS Scale factor y-QoS Assistance information z}
   The QoE-Aware QoS handling information may be stored in the QQF, or stored in NF2 (e.g. UDM/UDR).

At 3b, in some implementations, the NF3 (e.g. NWDAF) may determine QoE-Aware QoS handling information. The NF3 (e.g. NWDAF) may base this on historical monitoring. For example, the NF3 (e.g. NWDAF) may determine that for users aged 55-65, the bit rate requirement may be reduced by 10% and the QoE may still be good to the end user.
List of QoS Scale factors: {QoS Scale factor y-QoS Assistance information z}

The QoE-Aware QoS handling information may be stored in the QQF, or stored in NF2 (e.g. UDM/UDR).

Returning to FIG. 5A, at 4, the UE or a user of the UE may start a service requiring reserved transport (e.g. an XR application, etc.). If the current serving network does not support reserved transport, this may trigger the UE to deregister from the serving network and register to a new serving network. The decision to change serving network may based on the priority of the service or on some user preference. For example, the user may be prompted to either accept changing serving networks, or stay on the current serving network but accept that the performance may not be optimal.

At 5, in some implementations, the UE determines if the RAN node supports reserved transport. The RAN Node (e.g. base station) broadcasts system information in a System Information Block (SIB). The system information may include an indication that reserved transport is supported in the RAN node (e.g. via an options header field, via a flag or predetermined bit in a header, etc.). The system information may also indicate that services requiring reserved transport are only allowed, if the UE supports the QoE-aware QoS.

If the serving RAN node cannot be used by the UE for this service, in some implementations, this may trigger the UE to change serving RAN node. For example, the UE may perform a cell reselection or handover to a RAN node that does support reserved transport.

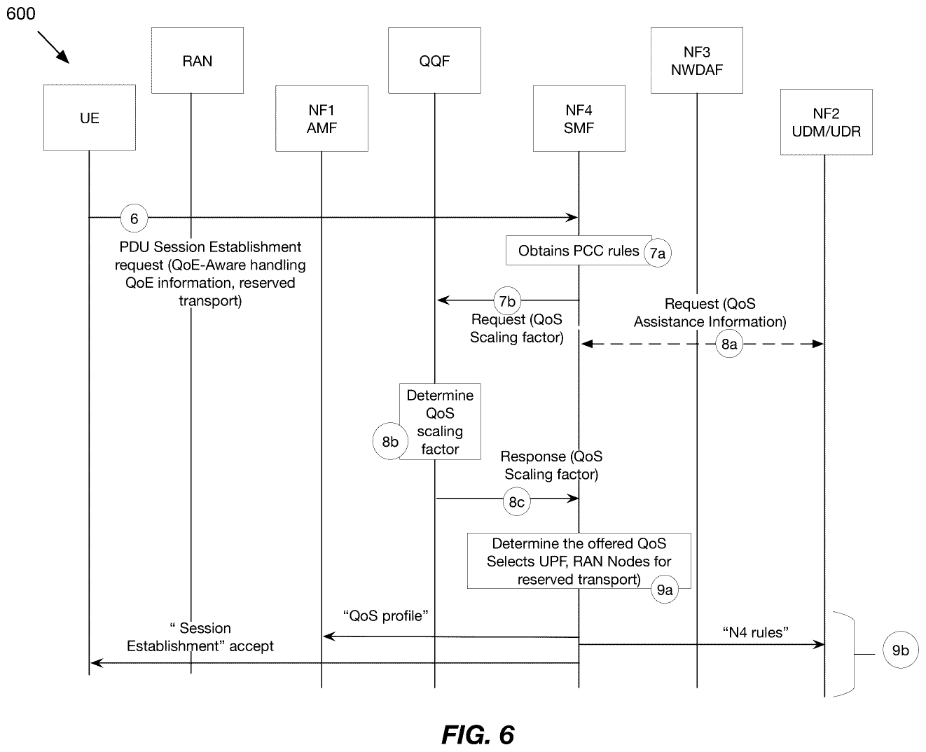

Continuing with the example signal flow diagram 600 of FIG. 6, at 6, in some implementations, the UE initiates a PDU session establishment (or PDU Session modification) by sending a PDU Session Establishment Request (or PDU Session Modification Request) message to NF4 (e.g. SMF). The message may include some or all of the following: an indication that UE wants QoE-aware QoS handling for this PDU session, an indication that UE wants reserved transport, QoE information, UE ID, and/or User ID. In some implementations, the NF4 (e.g. SMF) may establish a new PDU session (or modifies an existing PDU session).

At 7a, in some implementations, the NF4 (e.g. SMF) interacts with NF5 (e.g. PCF) to obtain policy rules for the PDU session. The policy rules provide NF4 (e.g. SMF) information on how to map services to QoS flows and also provides the required QoS for each of these QoS flows.

At 7b, in some implementations, the NF4 (e.g. SMF) sends a message to the QQF to retrieve a QoS scaling factor or factors. In the request, the NF4 (e.g. SMF) may provide an indication of the service, the UE identity, and/or the user identity. The request may also act as an implicit subscription request to the QQF—that is, a request for the QQF to notify the SMF of any changes in QoS Scaling factor or offered QoS for this service/UE/user.

At 8a, in some implementations, the QQF retrieves QoE Assistance information for the service/UE/user from NF3 (e.g. NWDAF), if such information is available. If not, the QQF may attempt to retrieve the QoE Assistance information from alternate sources, such as a UDM/UDR or by requesting the information from the UE or another such device or node.

At 8b, in some implementations, the QQF uses the obtained QoE Assistance information for the service/UE/user and determines the QoS Scaling factor, if any. As discussed above, the QoE Assistance information may include information to directly set the QoS Scaling factor; while in other implementations, the QoE Assistance information may have indirect information (e.g. a string of parameters to provide to an AI/ML system, etc.).

At 8c, in some implementations, the QQF sends a message to NF4 (e.g. SMF) that includes the QoS scaling factor.

At 9a, in some implementations, the NF4 (e.g. SMF) scales the required QoS (determined at 5a) for the QoS flow. NF4 (e.g. SMF) determines the offered QoS (based on the scaling factor returned from the QQF at 5b). The NF4 (e.g. SMF) may select the UPFs and RAN nodes based on their ability to provide reserved transport (these entities must be able to reserve the needed capacity to meet the QoS requirements).

At 9b, in some implementations, the NF4 (e.g. SMF) configures the user plane entities to provide the reserved transport and meet the offered QoS. For example the NF4 (e.g. SMF) may configure the UPF with N4 rules. For example, the NF4 (e.g. SMF) may configure the RAN node with QoS profile. For example, the NF4 (e.g. SMF) may configure the UE with QoS rules. As part of this configuration, the entities may be told to perform QoE monitoring. The configuration for the UE may include:
QoE monitoring—periodic or event driven. If event driven, the events that trigger the monitoring. If periodic, the time between monitoring.
QoE monitoring—the monitoring criteria (e.g. Global, Lag, out of sync, video quality, audio quality, etc.)
QoE monitoring—the monitoring granularity (e.g. per UE, per user per service, per service per use, etc.)
QoE reporting—periodic or event driven. If event driven, the events that trigger the reporting. If periodic, the time between monitoring.

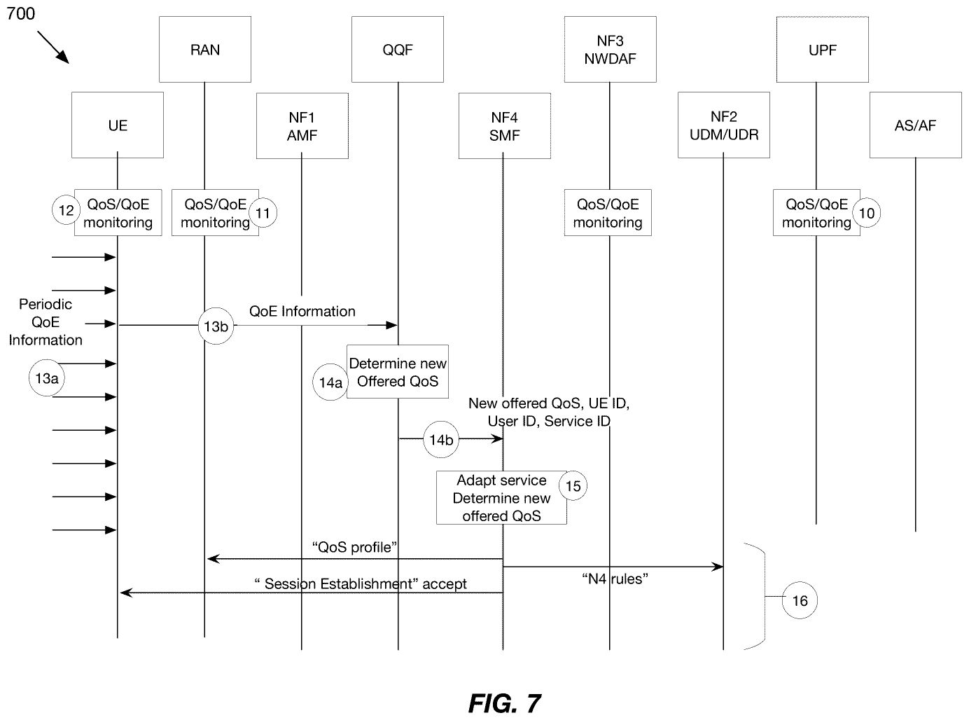

Turning to the signal flow diagram 700 of FIG. 7, at 10, the UPF may reserve capacity for the reserved transport flow, and may reserve capacity in the transport link between the UPF and the RAN node.

At 11, the RAN node may provide special handling for the reserved transport over the air interface. At 12, at the UE, the reserved transport may similarly result in special handling over the air interface. The UE may also trigger the application to start QoE monitoring and QoE reporting, according to the received configuration. In the remainder of the call flow, it is assumed that the UE is configured to monitor the QoE information periodically and to report the QoE information when the QoE score changes. In some implementations, the UE may periodically receive QoE and/or QoS measurements from other network entities (e.g. RAN, UPF, NWDAF, etc.).

Over time, at 13a, the UE periodically monitors QoE information. If and when the QoE score changes, at 13b in some implementations, the UE reports the QoE information to the QQF. Information may include: service ID, UE ID, user ID, QoE information, etc.

At 14a, in some implementations, the QQF may determine that the offered QoS for a service may be changed. For example, the QoE scores may indicate that the user is happy with the provided QoE. For example, the QQF may determine a new offered QoS.

At 14b, if the QQF determines a new offered QoS, the QQF may send a notification message to NF4 (e.g. SMF). The message may include: the service, the user UD, the UE ID, the new offered QoS.

At 15, in some implementations, based on the notification, the NF4 (e.g. SMF) may perform QoE-aware QoS handling. For example, NF4 (e.g. SMF) may modify the QoS flow transporting the service, so that the QoS flow provides the new offered QoS (received in 14b). For example, the SMF may redirect traffic via an alternate route, may modify packet priority headers, etc., or may otherwise modify the QoS flow to provide the determined level of QoS.

At 16, in some implementations, the (e.g. SMF) reconfigures the user plane entities to provide the reserved transport according to the offered QoS (received in Step 14b). For example the NF4 (e.g. SMF) may configure the UPF with N4 rules. For example, the NF4 (e.g. SMF) may configure the RAN node with QoS profile. For example, the NF4 (e.g. SMF) may configure the UE with QoS rules.

In some cases, the QQF has multiple sources of QoE information and/or QoE Assistance information, and the QQF may use a weighted combination of the information to determine a single scaling factor to apply to a QoS flow, or a single offered QoS to apply to a QoS flow. The weights may be pre-configured. Alternatively, the NWDAF may provide weights to the QQF to help determine the Offered QoS.

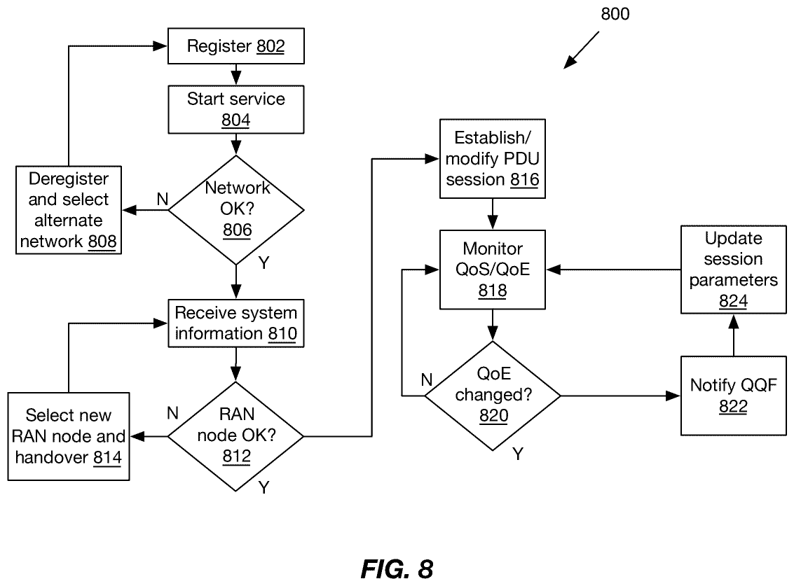

FIG. 8 is a flow chart of an implementation of a method 800 for QoE-Aware QoS handling of a flow. At 802, a UE may register with a serving network. Registering with the serving network may comprise transmitting a Registration Request message to a network node, such as an AMF. The message may include an identifier of the UE, an indication that the UE supports QoE-Aware QoS, an indication that that UE supports reserved transport, and QoE Assistance Information, and/or an identifier of the user. In some implementations, the QoE assistance information may include an identification of a QoS scale factor. In other implementations, the QoE assistance information may include an identification of one or more static and/or dynamic factors corresponding to QoS scale factors. The UE may receive an acceptance response for the registration from the AMF, if the AMF accepts the registration request. The response message may include an indication as to whether the network supports reserved transport and/or QoE-Aware QoS handling.

At 804, the UE may start a service or application requiring reserved transport, such as an XR application, media application, telepresence application, or similar application. In some implementations, the service or application may be executed by a different device and the UE may provide network connectivity for the service or application. Accordingly, in such implementations, the UE and other device may be considered together as a UE system. At 806, the UE may determine whether the serving network can support the reserved transport session for the service or application. Determining whether the serving network can support the reserved transport session may comprise performing one or more network measurements in some implementations. In other implementations, determining whether the serving network can support the reserved transport session may comprise examining a header or payload of the registration acceptance message to determine if a reserved transport flag or indicator is present or enabled, or otherwise indicates that the network is capable of providing the requested session. If not, then at 808, the UE may deregister (e.g. by sending a deregistration request to the AMF) and/or may select an alternate network and repeat 802-806 for the alternate serving network.

If the network can support the reserved transport session, then in some implementations at 812, the UE may determine whether the serving RAN can support the reserved transport session. Determining whether the RAN can support the reserved transport session may comprise performing one or more network measurements in some implementations. In other implementations, determining whether the RAN can support the reserved transport session may comprise receiving system information from the RAN, such as a broadcast SIB comprising an indication that reserved transport is supported in the RAN node (e.g. via an options header field, via a flag or predetermined bit in a header, etc.). The system information may also indicate that services requiring reserved transport are only allowed, if the UE supports the QoE-aware QoS. If the RAN is not capable of supporting the reserved transport session, at 814, the UE may initiate a handover procedure or similar procedure for switching to a different RAN and repeat 810-812.

If the RAN node can support the session, at 816, the UE may initiate a PDU session establishment (or PDU Session modification) by sending a PDU Session Establishment Request (or PDU Session Modification Request) message to the network (e.g. a SMF). The message may include some or all of the following: an indication that UE wants QoE-aware QoS handling for this PDU session, an indication that UE wants reserved transport, QoE information, UE ID, and/or a User ID. The SMF may establish a new PDU session or, in some implementations, may modify an existing PDU session.

During execution of the application, at 818, the UE may monitor a QoE score for the application. The score may be based on explicit indicators or values provided by a user (e.g. via a GUI interface, responsive to a survey or questionnaire, etc.) or based on implicit indicators (e.g. indicating user frustration). In some implementations, the score may be based on QoS measurements that may indicate a change in QoE, including network jitter, buffer levels, congestion indicators, etc. Monitoring the QoE score may comprise performing or collecting one or more network or application performance measurements. For example, in some implementations, a survey, questionnaire, or similar interface may be provided to a user of the UE to input an experience metric (e.g. indicating a positive experience, negative experience, neutral experience, an impression of delay or slowness, an indication of happiness or unhappiness, etc.). In some implementations, objective data may be gathered, such as round trip times, block error rates, throughput, buffer status, jitter, battery usage, processor utilization, etc. Accordingly, in many implementations, monitoring or collecting network or application performance measurements may comprise gathering or measuring objective metrics, gathering or measuring subjective metrics, or gathering or measuring a combination of objective and subjective measurements.

At 820, the UE may determine if the QoE has changed more than a threshold amount (e.g. if a change exceeds a threshold). If not, the UE may repeat 818-820. If so, at 822, the UE may notify the network (e.g. the QQF) by providing an indicator of the QoE change (e.g. QoS measurements, a QoE score, and/or any other information to allow the QQF to determine whether the network flow should be modified). Note that the change in score may be positive or negative, indicating an improvement or impairment in QoE, and the session flow may be modified accordingly. For example, in some implementations, if the QoE score is improved but the quality may be beyond what is required for the particular user and/or device environment, the QQF may take steps to reduce the QoS provided to the service and/or devote more network resources to other communications flows that could benefit (e.g. by reducing a resolution, increasing compression ratios, selecting a slower bandwidth connection or a more congested connection, by deprioritizing traffic, reducing a traffic guaranteed bit rate, reducing retransmission rates, modifying congestion window sizes, etc.). The QQF may provide updated parameters for the session to the UE, and at 824, the UE may update the parameters for the flow and continue executing and monitoring the application or service at 818.

Accordingly, the present disclosure is directed to implementations of systems and methods for UE operation to support QoE-aware QoS handling, and a QQF network function to support QoE-Aware QoS handling. In particular, implementations of the systems and methods discussed herein provide new QoS parameters tailored for 6G use cases, including the related information provisioned from the AF/AS; a mechanism for 6G systems to use QoE Assistance information to scale required QoS for a service; a mechanism to configure the UE to measure and report QoE information to the network; a new network function (QoE-Aware QoS Function or QQF) to manage QoE-Aware QoS handling; and/or a mechanism for the network (e.g. SMF) to configure QoS flows requiring reserved transport and/or enabled for QoE-Aware QoS handling.

In a first aspect, the present disclosure is directed to a method. The method includes transmitting, by a wireless transmit receive unit (WTRU) to a network, a registration request comprising quality-of-experience (QoE) assistance information. The method also includes receiving, by the WTRU from the network, a registration acceptance response indicating a QoE-Aware Quality-of-Service Function (QQF) of the network is configured to provide QoS flow control or QoS management for an application of the WTRU based on the QoE assistance information. The method also includes executing, by the WTRU, the application. The method also includes monitoring, by the WTRU, a QoE score during execution of the application. The method also includes responsive to a change in the QoE score, transmitting, by the WTRU to the QQF, one or more network or application performance measurements.

In some implementations, the registration request comprises an identifier of the WTRU. In some implementations, the registration request comprises an identifier of a user of the WTRU. In some implementations, the QoE assistance information comprises an identification of a QoS scale factor. In some implementations, the QoE assistance information comprises an identification of one or more static and/or dynamic factors corresponding to QoS scale factors.

In some implementations, the method includes transmitting, by the WTRU to the network, a request to establish or modify a protocol data unit (PDU) session for the application. In a further implementation, the request to establish or modify the PDU session comprises a reserved transport indicator. In another further implementation, the request to establish or modify the PDU session comprises a QoE-aware QoS handling indicator.

In some implementations, the network may be considered a first network, and the method includes determining, by the WTRU, that the first network cannot support a reserved transport session, and responsive to the determination: transmitting, by the WTRU to a second network, a second registration request comprising the QoE assistance information; and receiving, by the WTRU from the second network, a second registration acceptance response indicating a QQF of the second network is configured to provide QoS flow control or QoS management for the application of the WTRU based on the QoE assistance information.

In some implementations, the method includes determining, by the WTRU, that a radio access network (RAN) of the network cannot support a reserved transport session, and responsive to the determination, executing a handover procedure to another RAN node of the network.

In another aspect, the present disclosure is directed to a wireless transmit receive unit (WTRU), comprising one or more processors and one or more transceivers. The one or more processors are configured to transmit, via the one or more transceivers to a network, a registration request comprising quality-of-experience (QoE) assistance information. The one or more processors are also configured to receive, via the one or more transceivers from the network, a registration acceptance response indicating a QoE-Aware Quality-of-Service Function (QQF) of the network is configured to provide QoS flow control or QoS management for an application of the WTRU based on the QoE assistance information. The one or more processors are also configured to execute the application. The one or more processors are also configured to monitor a QoE score during execution of the application. The one or more processors are also configured to, responsive to a change in the QoE score, transmit, via the one or more transceivers to the QQF, one or more network or application performance measurements.

In some implementations, the registration request comprises an identifier of the WTRU. In some implementations, the registration request comprises an identifier of a user of the WTRU. In some implementations, the QoE assistance information comprises an identification of a QoS scale factor. In some implementations, the QoE assistance information comprises an identification of one or more static and/or dynamic factors corresponding to QoS scale factors.

In some implementations, the one or more processors are further configured to transmit, via the one or more transceivers to the network, a request to establish or modify a protocol data unit (PDU) session for the application. In a further implementation, the request to establish or modify the PDU session comprises a reserved transport indicator. In another further implementation, the request to establish or modify the PDU session comprises a QoE-aware QoS handling indicator.

In some implementations, the network may be considered a first network, and the one or more processors are further configured to determine that the first network cannot support a reserved transport session, and responsive to the determination: transmit, via the one or more transceivers to a second network, a second registration request comprising the QoE assistance information; and receive, via the one or more transceivers from the second network, a second registration acceptance response indicating a QQF of the second network is configured to provide QoS flow control or QoS management for the application of the WTRU based on the QoE assistance information.

In some implementations, the one or more processors are further configured to determine that a radio access network (RAN) of the network cannot support a reserved transport session, and responsive to the determination, execute a handover procedure to another RAN node of the network.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method, comprising:
transmitting, by a wireless transmit receive unit (WTRU) to a network, a registration request comprising quality-of-experience (QoE) assistance information;
receiving, by the WTRU from the network, a registration acceptance response indicating a QoE-Aware Quality-of-Service Function (QQF) of the network is configured to provide QoS flow control or QoS management for an application of the WTRU based on the QoE assistance information;
executing, by the WTRU, the application;
monitoring, by the WTRU, a QoE score during execution of the application; and
responsive to a change in the QoE score, transmitting, by the WTRU to the QQF, one or more network or application performance measurements.

2. The method of claim 1, wherein the registration request comprises an identifier of the WTRU.

3. The method of claim 1, wherein the registration request comprises an identifier of a user of the WTRU.

4. The method of claim 1, wherein the QoE assistance information comprises an identification of a QoS scale factor.

5. The method of claim 1, wherein the QoE assistance information comprises an identification of one or more static and/or dynamic factors corresponding to QoS scale factors.

6. The method of claim 1, further comprising transmitting, by the WTRU to the network, a request to establish or modify a protocol data unit (PDU) session for the application.

7. The method of claim 6, wherein the request to establish or modify the PDU session comprises a reserved transport indicator.

8. The method of claim 6, wherein the request to establish or modify the PDU session comprises a QoE-aware QoS handling indicator.

9. The method of claim 1, wherein the network is a first network, and further comprising determining, by the WTRU, that the first network cannot support a reserved transport session, and responsive to the determination:
transmitting, by the WTRU to a second network, a second registration request comprising the QoE assistance information; and
receiving, by the WTRU from the second network, a second registration acceptance response indicating a QQF of the second network is configured to provide QoS flow control for the application of the WTRU based on the QoE assistance information.

10. The method of claim 1, further comprising determining, by the WTRU, that a radio access network (RAN) of the network cannot support a reserved transport session, and responsive to the determination:
executing a handover procedure to another RAN node of the network.

11. A wireless transmit receive unit (WTRU), comprising one or more processors and one or more transceivers;
wherein the one or more processors are configured to:
transmit, via the one or more transceivers to a network, a registration request comprising quality-of-experience (QoE) assistance information,
receive, via the one or more transceivers from the network, a registration acceptance response indicating a QoE-Aware Quality-of-Service Function (QQF) of the network is configured to provide QoS flow control for an application of the WTRU based on the QoE assistance information,
execute the application,
monitor a QoE score during execution of the application, and
responsive to a change in the QoE score, transmit, via the one or more transceivers to the QQF, one or more network or application performance measurements.

12. The WTRU of claim 11, wherein the registration request comprises an identifier of the WTRU.

13. The WTRU of claim 11, wherein the registration request comprises an identifier of a user of the WTRU.

14. The WTRU of claim 11, wherein the QoE assistance information comprises an identification of a QoS scale factor.

15. The WTRU of claim 11, wherein the QoE assistance information comprises an identification of one or more static and/or dynamic factors corresponding to QoS scale factors.

16. The WTRU of claim 11, wherein the one or more processors are further configured to transmit, via the one or more transceivers to the network, a request to establish or modify a protocol data unit (PDU) session for the application.

17. The WTRU of claim 16, wherein the request to establish or modify the PDU session comprises a reserved transport indicator.

18. The WTRU of claim 16, wherein the request to establish or modify the PDU session comprises a QoE-aware QoS handling indicator.

19. The WTRU of claim 11, wherein the network is a first network, and wherein the one or more processors are further configured to determine that the first network cannot support a reserved transport session, and responsive to the determination:
transmit, via the one or more transceivers to a second network, a second registration request comprising the QoE assistance information; and
receive, via the one or more transceivers from the second network, a second registration acceptance response indicating a QQF of the second network is configured to provide QoS flow control or QoS management for the application of the WTRU based on the QoE assistance information.

20. The WTRU of claim 11, wherein the one or more processors are further configured to determine that a radio access network (RAN) of the network cannot support a reserved transport session, and responsive to the determination:
execute a handover procedure to another RAN node of the network.
